(19) United States
(12) Patent Application Publication
(10) Pub. No.: US 2020/0106829 A1
(43) Pub. Date: Apr. 2, 2020

(54) Fluid Client Server Partitioning of Machines Learning, AI Software, and Applications

(71) Applicant: Brainworks Foundry, Inc., Arlington, VA (US)

(72) Inventors: Phillip Alvelda, VII, Arlington, VA (US); Markus Krause, Oakland, CA (US)

(21) Appl. No.: 16/591,363

(22) Filed: Oct. 2, 2019

Related U.S. Application Data
(60) Provisional application No. 62/739,898, filed on Oct. 2, 2018.

(51) Int. Cl. H04L 29/08; H04L 29/06

(52) U.S. Cl. CPC H04L 67/10; G06N 20/00; H04L 67/2842; H04L 67/42

(57) ABSTRACT

The present invention relates to systems and methods suitable for partitioning processes between devices. In particular, the present invention relates to partitioning client devices and server devices based on the performance and available resources of the respective devices to efficiently execute artificial intelligent, machine learning, and other processes.

### CROSS-REFERENCE TO RELATED APPLICATION(S)

This application claims priority to, and the benefit of, co-pending U.S. Provisional Application No. 62/739,898, filed Oct. 2, 2018, for all subject matter common to both applications. The disclosure of said provisional application is hereby incorporated by reference in its entirety.

### FIELD OF THE INVENTION

The present invention relates to systems and methods suitable for partitioning processes between devices. In particular, the present invention relates to partitioning client devices and server devices based on the performance and available resources of the respective devices to efficiently execute artificial intelligent, machine learning, and other processes.

### BACKGROUND

Generally, current machine learning and artificial intelligence (AI) system code generally resides entirely either on client device hardware and firmware, or runs on high performance server systems. This means that before any devices or services are developed, decisions must be made a-priori to allocate the computation task to either a low power-limited performance single chip custom AI processor on the client device, or suffer the telemetry burden and perform more difficult processing on a distributed cloud service. But a new range of open AI applications demand more flexible provisioning and data protection features for a growing range of new AI driven applications that have yet to be developed.

### SUMMARY

There is a need for improvements for providing processing artificial intelligence algorithms, machine learning, and other applications. The present invention provides, in various embodiments solutions to address this need, in addition to having other desirable characteristics.

An embodiment of the present invention includes a method for fluid client and server partitioning, comprising: receiving, by at least one server processor, client device self-assessment data representing a self-assessment of resources and functionalities by each client device of one or more client devices in communication with the at least one server processor; determining, by the at least one server processor, a distribution of a plurality of processing tasks of at least one process pipeline to be assigned across the at least one server processor and at least one of the one or more client devices based on the received client device self-assessment data; distributing, by the at least one server processor, executable code and process data associated with each processing task of the plurality of processing tasks from a central caching system to the at least one of the one or more client devices, according to the distribution; deriving, by the at least one server processor, a respective result for each respective processing task of the plurality of processing tasks distributed to the at least one server processor; receiving, by the at least one server processor, results from the at least one of the one or more client devices; and storing, by the at least one server processor, the respective result and the received results of the at least one process pipeline in a shared data storage.

The embodiment of the present invention may also include the method for fluid client and server partitioning, wherein the self-assessment comprises at least one of network throughput, processor load, memory storage used and free, and embedded camera capabilities.

Embodiments of the present invention further include the method for fluid client and server partitioning, further comprising maintaining a library of self-assessment data for each client device.

The embodiment of the present invention may also include the method for fluid client and server partitioning, wherein the executable code and process data are at least one of machine learning algorithms and artificial intelligence algorithms and the date they operate one and generate.

The embodiment of the present invention may also include the method for fluid client and server partitioning, the at least one of the one or more client devices is a mobile device with a camera and the executable code and process data is processed within a web browser on the mobile device; and, wherein the executable code is a vision processing code module that act on an incoming stream from the camera to identify a face of a user and mask the face as the results of the processing task.

The embodiment of the present invention may also include the method for fluid client and server partitioning, wherein the at least one server processor is part of a server within a server cluster.

The embodiment of the present invention may also include the method for fluid client and server partitioning, further comprising determining, by the at least one server processor, a redistribution of each respective result from each respective processing task to the at least one of the one or more client devices; wherein the processing task distributed to the at least one of the one or more client devices requires usage of the respective result derived by the at least one server processor.

The embodiment of the present invention may also include the method for fluid client and server partitioning, wherein the process data for the processing tasks are provided within the shared memory for asynchronous access by the at least one of the one or more client devices when performing their respective processing tasks.

An embodiment of the present invention includes a system for fluid client and server partitioning, comprising: a shared data storage; a central caching system to store data associated with at least one process pipeline; a server in communication with the shared data storage and the central caching system; wherein the server comprises at least one server processor configured to perform the steps of: receiving client device self-assessment data representing a self-assessment of resources and functionalities by each client device of one or more client devices in communication with the at least one server processor; determining a distribution of a plurality of processing tasks of the at least one process pipeline to be assigned across the at least one server processor and at least one of the one or more client devices based on the received client device self-assessment data; distributing executable code and process data associated with each processing task of the plurality of processing tasks from the central caching system to the at least one of the one or more client devices, according to the distribution; deriving a respective result for each respective processing task of the plurality of processing tasks distributed to the at least one server processor; receiving results from the at least one of the one or more client devices; and storing the respective result and the received results of the at least one process pipeline in the shared data storage.

The embodiment of the present invention may also include wherein the self-assessment comprises at least one of network throughput, processor load, memory storage used and free, and embedded camera capabilities.

The embodiment of the present invention may also include wherein the at least one server processor is further configured to maintain a library of self-assessment data for each client device.

The embodiment of the present invention may also include wherein the executable code and process data are at least one of machine learning algorithms and artificial intelligence algorithms and the date they operate one and generate.

The embodiment of the present invention may also include wherein the at least one of the one or more client devices is a mobile device with a camera and the executable code and process data is processed within a web browser on the mobile device; and, wherein the executable code is a vision processing code module that act on an incoming stream from the camera to identify a face of a user and mask the face as the results of the processing task.

The embodiment of the present invention may also include wherein the server is part of a server cluster.

The embodiment of the present invention may also include wherein the at least one server processor is further configured to determine a redistribution of each respective result from each respective processing task to the at least one of the one or more client devices; and, wherein the processing task distributed to the at least one of the one or more client devices requires usage of the respective result derived by the at least one server processor.

The embodiment of the present invention may also include wherein the process data for the processing tasks are provided within the shared memory for asynchronous access by the at least one of the one or more client devices when performing their respective processing tasks.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of a system for implementation of the methods in accordance with the present disclosure;

FIG. 2 is a diagram depicting a process of performing partitioning processes between devices in accordance with the present disclosure; and

FIG. 3 is a diagrammatic illustration of a high-level architecture for implementing processes in accordance with the present disclosure.

### DETAILED DESCRIPTION

An illustrative embodiment of the present invention relates to systems and methods for a flexible and modular machine learning and AI processing system that can re-allocate, and re-provision modular computational units to execute either on centralized cloud server platforms, or be provisioned to, and executed on, client devices, or have subsets of larger computational tasks partitioned and shared between client and server devices. The client devices can include an array of consumer products such as smartphones, web cameras, computers and tablets, or any networked combination of the above. This new architecture and system allows for real-time tuning and optimization of how and where AI computing is done to achieve efficient AI processing. The systems and methods of the present disclosure can also balance the demands of data telemetry and data storage, as driven by local versus remote processing, networking, and storage capabilities.

The systems and methods of the present disclosure can implement a function call, parameter passing, and data access framework that abstracts the difference between local data and execution versus remote data, so that general application logic and data access is independent of where the processing modules or data resides, whether local or remote. This allows for the same business logic and application level code to run on a wide variety of differently distributed systems independent of where the computational components or data reside. Different systems can then use the same code to run even if they are composed of different processing systems and data repositories and network topologies or localities.

The data can include abstract human readable personal data that can be partitioned from encoded and encrypted machine-readable data in complex distributed data stores such as neural weight matrices, so that any private data can be stored separately, in either local or remote memory storage.

The present disclosure makes use of a code base and library of executable files where machine learning and AI algorithms, as well as the data they operate on and generate, are partitioned in several important ways for execution by different devices in parallel. Computational source and executable code can be partitioned such that separate machine learning pipelines and separate stages in processing pipelines can reside and be executed in either local or remote processors, and operate on, and store data, either remotely or locally. In other words, the systems and methods of the present invention can assess and partition responsibilities for different devices when executing a combination of artificial intelligence algorithms, machine learning algorithms, and other applications in an efficient manner. For example, a mobile phone with limited processing and storage capability can lightly process local video from its embedded camera, but then stream the video over the cellular networks to a remote cluster of high-performance servers to run massive AI algorithms in parallel with hundreds of CPUs working in aggregate to generate analytical results. The results can then be fed back to the mobile phone hundreds of times faster than the phone might have computed the same analytical results itself. At the same time, the massive volumes of streaming video data that would never fit on the mobile phone's local memory, are instead stored within the large disk archive in the server cluster. As computing and storage needs ramp up for data-rich machine learning and AI tasks, the systems and methods of the present disclosure become enabling in allowing compute and storage to happen wherever it is most efficient and cost-effective, and to process things much faster than any single device could have managed without the larger system.

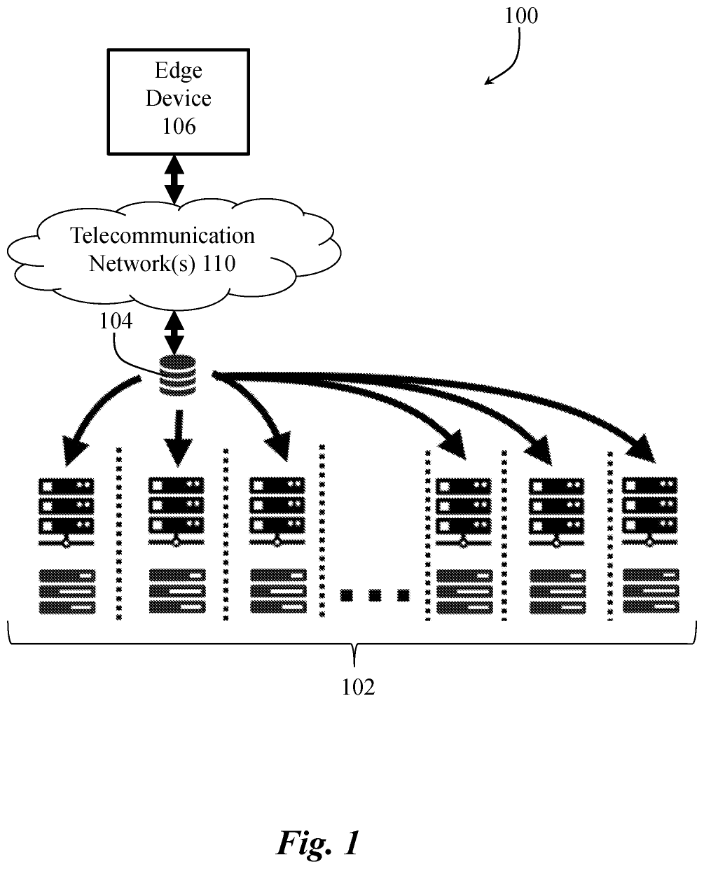

FIGS. 1 through 3, wherein like parts are designated by like reference numerals throughout, illustrate an example embodiment or embodiments of improved operation for partitioning AI processes over different devices, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

Referring to FIG. 1, an example processing partitioning system 100 for implementing the present disclosure is depicted. Specifically, FIG. 1 depicts an illustrative system 100 for partitioning data processing pipelines (e.g., for AI and machine learning algorithms) over a plurality of client devices (user devices 106) and a cluster of working server devices (computing devices 102). In some embodiments, the system 100 can be a combination of hardware and software configured to carry out aspects of the present disclosure. For example, the system 100 can include a complex distributed client server architecture constructed from a plurality of user devices 106, servers 102, and/or server clusters. In some embodiments, the computing devices 102 can be working servers with specialized software and databases designed for processing data. For example, the system 100 can be software installed on a computing device 102, a web based application provided by a computing device 102 which is accessible by other computing devices (e.g., user devices 106), a cloud based application accessible by computing devices, or the like.

In some embodiments, the system 100 can include a cluster of computing devices 102 designed to operate in parallel to perform analysis on data stored within a shared memory. As would be appreciated by one skilled in the art, the computing devices 102 can include a single computing device, a collection of computing devices in a network computing system, a cloud computing infrastructure, or a combination thereof. The combination of hardware and software that make up the system 100 are specifically configured to provide a technical solution to a particular problem utilizing an unconventional combination of steps/operations to carry out aspects of the present disclosure. In particular, the system 100 is designed to execute a unique combination of steps to provide a novel approach to dynamically partitioning processing tasks for complex algorithms (e.g., artificial intelligence, machine learning, etc.) between multiple devices.

In some embodiments, the system 100 can include a storage system 104 communicatively attached to the computing device(s) 102. The storage system 104 can include any combination of computing devices configured to store and organize a collection of data. For example, storage system 104 can be a local storage device on the computing device 102, a remote database facility, or a cloud computing storage environment. The storage system 104 can also include a database management system utilizing a given database model configured to interact with a user for analyzing the database data.

In some embodiments, the system 100 can include a plurality of user devices 106 acting as client devices. The plurality of user devices 106 can be any combination of internet capable devices (ICD) capable of being able to communicate with the computing device(s) 102 and/or the storage system 104. For example, the user devices 106 can be part of and/or connected to any ICD device that can establish a connection to another device over a communication medium using connection methods, including but are not limited to, protocols such as HyperText Transfer Protocol (HTTP)/HyperText Transfer Protocol Secure (HTTPS), Transmission Control Protocol (TCP)/User Datagram Protocol (UDP), etc. Using the connection, the computing device(s) 102 and/or the storage system 104 can act as a host (centralized or distributed), for the user devices 106, providing the functionality of the present disclosure. Any combination of computing devices with a built-in camera, an Internet connection, and some modest processing capability can be a user device 106, for example, a device, including mobile phones, tablets. computers, webcams, smart TVs, smart home appliances, etc.

In some embodiments, user devices 106 can include a camera or other image capturing device for use in accordance with the present disclosure. The camera can include any combination of devices that can record image data and/or allows transfer of image data to and from the user devices 106. For example, examples of cameras can include mobile phone cameras, closed-circuit television (CCTV) systems, cameras integrated in laptops tablets, personal computers, photo and video cameras, external webcams, digital camcorder, wrist watches, game consoles, smart home appliances, including smart televisions and refrigerators, cars, smart glasses, eBook readers, etc. The transfer of image data to the user devices 106 can include any method suitable including but not limited to direct streaming over a wireless or hard-wired connection as well as using a storage device such as a hard drive or a memory card or cloud storage.

In some embodiments, the user devices 106 can provide image data, image streams, and/or other data to the computer devices 102. For example, the user devices 106 may include a digital camera or a digital imaging device in the possession of any party, which may upload imagery to, e.g., a storage platform such as a cloud service for provision to the computer devices 102 and storage system 104. Although examples using cameras capturing image data are provided herein, the user devices 106 can include and use any combination of data acquisition devices capturing any combination of data without departing from the scope of the present disclosure.

In some embodiments, the computing devices 102, 104, 106, can be configured to establish a connection and communicate over the telecommunication network(s) 110 to carry out aspects of the present disclosure. The telecommunication network(s) 110 can include any combination of known networks. For example, the telecommunication network(s) 110 may be any combination of a mobile network, WAN, LAN, or other type of network. The telecommunication network(s) 110 can be used to exchange data between the computing devices 102, 104, 106, exchange data with the storage system 104, and/or to collect data from additional sources.

In operation, the system 100 of the present disclosure can be designed to create a system for efficient processing of data, algorithms, and/or applications. This technical improvement can be realized by implementing a unique combination of steps for partitioning processes, pipelines, pipeline stages, and the data they operate on to generate an adaptable and efficient artificial intelligence and machine learning processing system. The systems and methods of the present disclosure minimize the amount of data transfers necessary for a machine learning and AI execution platform, a specially critical system load as data sets increase rapidly in volume. The present disclosure also serves to partition the execution of compute-intensive operations across a family of machines and processes so that in aggregate, they can compute difficult AI and machine learning results much faster than single process algorithms.

In some embodiments, the system 100 can implement a function call, parameter passing, and data access framework that abstracts the difference between local data and execution versus remote data, so that general application logic and data access is independent of where the processing modules or data resides, whether local or remote. This allows for the same business logic and application level code to run on a wide variety of differently distributed systems independent of where the computational components or data reside. Different systems can then use the same code to run even if they are composed of different processing systems and data repositories and network topologies or localities.

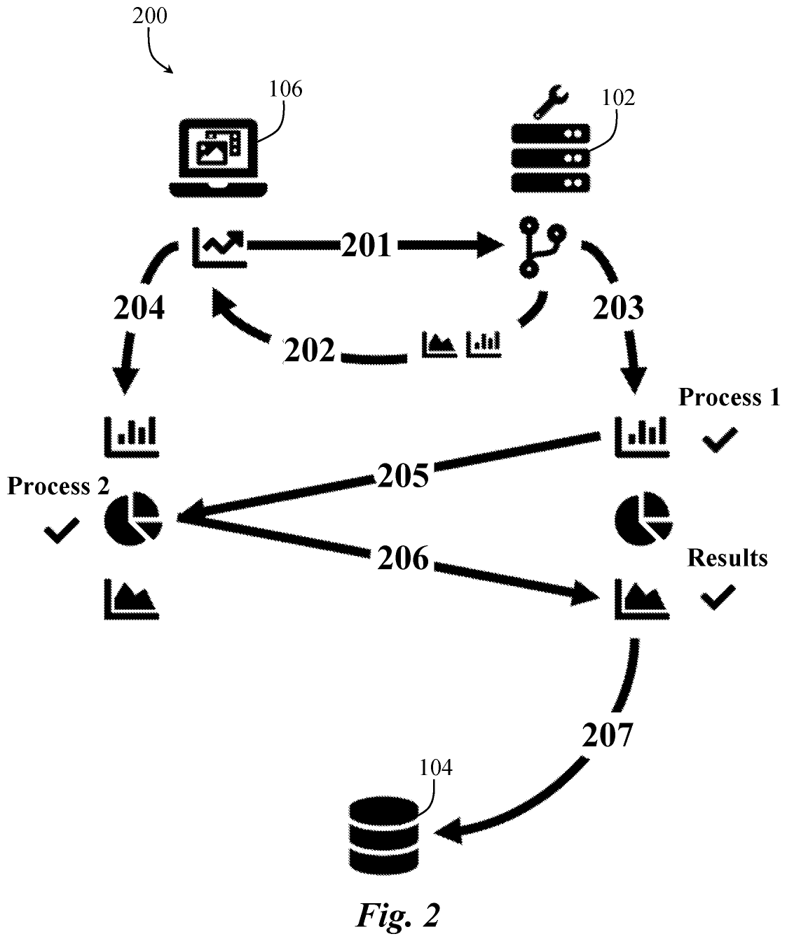

Referring to FIG. 2, a process 200 is provided for partitioning which processing tasks should be executed by which devices (e.g., locally, remotely, etc.) and where the data should be stored (e.g., locally, remotely, etc.). The process 200 can be implemented using the devices (102, 106) discussed with respect to FIG. 1. The process 200 can be used to determine, in real time, which processing tasks should run edge/client side and which should run server side. In some embodiments, a combination of computational source and executable code can be partitioned such that separate AI and machine learning pipelines and separate stages in processing pipelines can reside and be executed in either local or remote processors, and operate on, and store data, either remotely or locally. In other words, the process 200 can be used to determine which processing pipelines and/or pipeline stages for AI algorithms, machine learning algorithms, etc. should be processed by which devices. This process 200 operates in contrast to conventional processes in which roles are statically defined as to which device performs which processing tasks, as defined by the software installed on the respective devices.

At step 201 each edge device 106 can run a self-assessment service designed to evaluate the functionality and/or performance of that edge device 106 through a client. For example, the edge device 106 can evaluate a combination of hardware components, available capacity, etc. through a web interface. In some embodiments, the self-assessments can include real time assessments of network throughput, processor load, memory storage used and free, and embedded camera capabilities in resolution, frame rate, bit depth, etc. In some embodiments, the system 100 can maintain a library of device capabilities that stores, updates and maintains records include processing, telemetry and data storage capabilities of any supported client edge device 106 and server computing devices 102. The library can be stored within one of the computing devices 102 and/or the storage system 104. Once the self-assessment is completed, the edge device 106 can transmit the results to a server 102 for further evaluation. In some embodiments, the server can integrate the received self-assessments along with the current state of other remote elements of the server clusters, edge devices, load, and other factors, and can apply programmable logic to decide where to dispatch the individual functional program modules or processing tasks to be executed where processor capability is most available, and direct data storage to designated areas, depending on sensitivity and permanence requirements.

At step 202 the server 102 evaluates all of the assessments provided by a plurality of edge devices 106. During the evaluation, the server 102 can determine which and how many of the edge devices 106 and/or other servers 102 should be employed for particular processing tasks. In some embodiments, the server 102 can have access to a code base and library of executable files where machine learning and AI algorithms, as well as the data they operate on and generate, are available for use and/or distribution for execution by other devices 102, 106. Based on the assessment by the server 102, the edge device 106 and/or other servers 102 can receive the components (e.g., algorithms, pipelines, pipeline stages, etc.) that will run on, and/or across the edge in aggregate across multiple devices.

In an example embodiment, the server 102 can determine that a remote Internet connected mobile phone client has an embedded video camera, as well as an open Web socket with the server cluster, a live input stream from the camera, and an industry standard web browser with Javascript and WebGL execution capabilities. So the server 102 then pushes Javascript code modules into the phone browser to execute a user interface, and vision processing code modules that act on the incoming phone video stream to identify patient faces, select and mask the faces locally on the phone (about the limit of what AI processing a phone can do in real-time), and then stream the masked facial video segments to the high-performance computing server cluster for detailed analysis of the patient to extract a wide range of health biometrics, as discussed with respect to U.S. application Ser. No. 16/590,000, incorporated herein by reference. This is a combined process that would be impossible on the phone alone, unsupported by the remote cluster.

Step 202 can also include determining which processing tasks should remain to be executed by the server 102 itself. In some embodiments, the system 100 can maintain an efficient distributed data and executable code caching system that can dispatch code modules and data sets where they are needed when they are needed. For example, the caching system can be stored within one of the computing devices 102 and/or the storage system 104 for distributing executable code and data sets to the appropriate devices. In some embodiments, edge devices 106 can preloaded with the algorithms/processes that is being assigned or are they sent along with the instructions to perform those tasks from the server 101 and/or the cache system. In some embodiments, code modules are sent in real-time and are formatted to work within an existing web browser and/or a native application previously installed on the edge devices 106.

In some embodiments, the system 100 can include a measurement and analytics tool that monitors performance semaphores from each processing task module (one of the modular code units that can be partitioned and distributed to remote client devices for execution) in terms of a multiplicity of metrics can including, but not be limited to overall system performance by total execution time, latency, clock cycles, power dissipation, system accuracy and precision, and failure, transactional, and other logs. The multiplicity of metrics can include, but not be limited to resource utilization such as network performance, available and utilized bandwidth, goodput, and latency, CPU and GPU performance and load, and memory and large-scale storage throughput, load, capacity. In some embodiments, the server 102 can have a supervisory tool that uses the libraries, caches, and analytics to continually tune where tasks should be executed. These functional units are usually located within a control server (out of a server 102 cluster), but can reside in any client device as well.

At step 203 the server 102 starts the processing tasks that will run on the server 102. In the example flow provided in FIG. 2, the server 102 has assigned itself Process 1 for execution. In some embodiments, the server 102 can reserve only the resources needed for those processes, leaving other resources available for other tasks. This is an important capability so that cluster implementations can maintain tunable levels of free resources to respond to unexpected spikes in processing demand.

At step 204 the edge devices 106 receives and starts the processing tasks that have been assigned by the server 102. In some embodiments, the edge devices 106 uses all the available resources to be used only for this process. This can be a tunable parameter that can be configured depending on whether that particular process step in a larger task pipeline is the computational bottleneck. In the example flow provided in FIG. 2, the server 102 has assigned the edge device 106 with the task of executing Process 2. Depending on which processes are assigned to which devices, the diagram for FIG. 2 may change. However, the final database access is always performed by the server 102 (step 207) to guarantee data integrity and security.

At step 205 the server 102 transmits the results from its own processing tasks that are required for the edge devices 106 to carry out their assigned processing tasks. For example, as depicted in FIG. 2, the results for Process 1 are shared with edge device 106 for executing the Process 2. At step 206 the edge devices 106 uses the results provided by the server 102 (e.g., results from Process 1) to run its assigned process and returns the results of those processes to the server 102. Since the client software modules are designed to run asynchronously, they take what data is processed when it supplied without blocking other processes from accessing that data.

At step 207 the server 102 saves the final results in a storage system 104. Depending on the type of information being stored, the data can be deidentified, encrypted, etc. to be in compliance with the appropriate regulations, for example, HIPAA and GDPR. In some embodiments, human readable personal data can be partitioned from encoded and encrypted machine-readable data in complex distributed data stores such as neural weight matrices, such that any private data can be stored separately, in either local or remote memory storage.

In some embodiments, the libraries and caches for use by the process 200 can be periodically updated with the latest high-performance UI and local client code pushed into the client device web application framework of the edge devices 106, upon every access. The server-side analysis code can also be extensible independently of the client code framework for the edge devices 106. This allows the server 102 and edge devices 106 to be able to be up to date with the latest processes without having to reinstall software and/or update the client version. For example, every quarter, new algorithm pipelines can be added to operate in parallel to monitor and save data, for example, measuring and saving biometric data for patients, as discussed with respect to U.S. application Ser. No. 16/590,000, incorporated herein by reference.

In an example operation, the system 100 of the present disclosure can provide a continuous non-contact computer vision based vital sign measurement that exploits local execution environment and data sandbox of generic web browser that operate on most modern smartphones, tablets and computers in conjunction with remote high-performance computing server clusters in cloud service points-of-presence. The system 100 can use process 200 to partition processing pipelines (AI, machine learning, etc. algorithms) for each tracked vital measurement for execution by different devices 102, 106.

The example implementation of a vital sign measurement system can be set up for remote tele-medicine use. Important UI and facial location AI and machine learning modules can be exported for execution on the local client device (such as a video camera equipped mobile phone) to localize and mask a patient's face and snip 5-second video segments of the masked face area for upload to a remote server cluster for higher-performance AI and/or machine learning processing to extract a growing range of biometric signals including heart rate and variability, respiration rate, and blood pressure, for example, as discussed with respect to U.S. application Ser. No. 16/590,000, incorporated herein by reference. The complete user interface, and patient face localization and video region-of-interest masking code can be automatically pushed to the phone browser capable of accessing its built-in camera feed, and uploading the date to a remote server for advanced processing where an entire cluster of machines operates on the masked video data in parallel to generate a significant range of biometric health data all at once.

Another example instantiation of this invention can be a similar computer vision based biometric vital sign measurement system that is implemented entirely on one local computing system mounted on a push cart. The push cart can include all of the computational resources and data storage residing on a single machine. This the push cart device can be designed to perform the same functionality as the above instantiation for tele-medicine, but can be designed to replace the push-cart vital sign measurements used by hospitals, highlighting the flexibility of the architecture. Both instantiations can run virtually identical business logic and application level code, while accommodating very different hardware platforms necessitated by different use cases.

In some embodiments, when dealing with protected or private information, the system 100 can be designed to comply with certain legal regulation (e.g., HIPAA compliance) for the security of sensitive patient information. Although processes are partitioned between device, the system 100 can be configured such that sensitive information never leaves the patient's local mobile handset which is under their own control. In some embodiments, anonymized neural encoded data, useful for aggregate system training and improvement, can be transmitted to the server systems to optimize and improve future versions of the software.

Although the examples provided herein are related to monitoring biometrics for patients, the system 100 of the present disclosure can be applied to any combination of applications, for example, autonomous vehicle management and control, education, energy generation and management, and transportation.

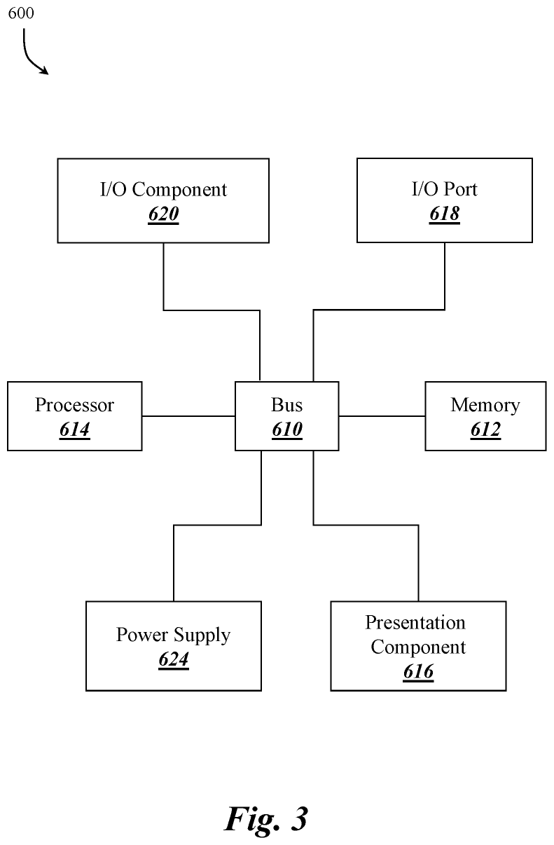

Any suitable computing device can be used to implement the computing devices 102, 104, 106 and methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 600 is depicted in FIG. 3. The computing device 600 is merely an illustrative example of a suitable computing environment and in no way limits the scope of the present disclosure. A “computing device,” as represented by FIG. 3, can include a “workstation,” a “server,” a “laptop,” a “desktop,” a “hand-held device,” a “mobile device,” a “tablet computer,” or other computing devices, as would be understood by those of skill in the art. Given that the computing device 600 is depicted for illustrative purposes, embodiments of the present disclosure may utilize any number of computing devices 600 in any number of different ways to implement a single embodiment of the present disclosure. Accordingly, embodiments of the present disclosure are not limited to a single computing device 600, as would be appreciated by one with skill in the art, nor are they limited to a single type of implementation or configuration of the example computing device 600.

The computing device 600 can include a bus 610 that can be coupled to one or more of the following illustrative components, directly or indirectly: a memory 612, one or more processors 614, one or more presentation components 616, input/output ports 618, input/output components 620, and a power supply 624. One of skill in the art will appreciate that the bus 610 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 3 is merely illustrative of an exemplary computing device that can be used to implement one or more embodiments of the present disclosure, and in no way limits the invention.

The computing device 600 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 600.

The memory 612 can include computer-storage media in the form of volatile and/or nonvolatile memory. The memory 612 may be removable, non-removable, or any combination thereof. Exemplary hardware devices are devices such as hard drives, solid-state memory, optical-disc drives, and the like. The computing device 600 can include one or more processors that read data from components such as the memory 612, the various I/O components 616, etc. Presentation component(s) 616 present data indications to a user or other device. Exemplary presentation components include a display device, speaker, printing component, vibrating component, etc.

The I/O ports 618 can enable the computing device 600 to be logically coupled to other devices, such as I/O components 620. Some of the I/O components 620 can be built into the computing device 600. Examples of such I/O components 620 include a microphone, joystick, recording device, game pad, satellite dish, scanner, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method for fluid client and server partitioning, comprising:
receiving, by at least one server processor, client device self-assessment data representing a self-assessment of resources and functionalities by each client device of one or more client devices in communication with the at least one server processor;
determining, by the at least one server processor, a distribution of a plurality of processing tasks of at least one process pipeline to be assigned across the at least one server processor and at least one of the one or more client devices based on the received client device self-assessment data;
distributing, by the at least one server processor, executable code and process data associated with each processing task of the plurality of processing tasks from a central caching system to the at least one of the one or more client devices, according to the distribution;
deriving, by the at least one server processor, a respective result for each respective processing task of the plurality of processing tasks distributed to the at least one server processor;
receiving, by the at least one server processor, results from the at least one of the one or more client devices; and
storing, by the at least one server processor, the respective result and the received results of the at least one process pipeline in a shared data storage.

2. The method of claim 1, wherein the self-assessment comprises at least one of network throughput, processor load, memory storage used and free, and embedded camera capabilities.

3. The method of claim 1, further comprising maintaining a library of self-assessment data for each client device.

4. The method of claim 1, wherein the executable code and process data are at least one of machine learning algorithms and artificial intelligence algorithms and the date they operate one and generate.

5. The method of claim 1, the at least one of the one or more client devices is a mobile device with a camera and the executable code and process data is processed within a web browser on the mobile device.

6. The method of claim 5, wherein the executable code is a vision processing code module that act on an incoming stream from the camera to identify a face of a user and mask the face as the results of the processing task.

7. The method of claim 1, wherein the at least one server processor is part of a server within a server cluster.

8. The method of claim 1, further comprising determining, by the at least one server processor, a redistribution of each respective result from each respective processing task to the at least one of the one or more client devices.

9. The method of claim 8, wherein the processing task distributed to the at least one of the one or more client devices requires usage of the respective result derived by the at least one server processor.

10. The method of claim 1, wherein the process data for the processing tasks are provided within the shared memory for asynchronous access by the at least one of the one or more client devices when performing their respective processing tasks.

11. A system for fluid client and server partitioning, comprising:
a shared data storage;
a central caching system to store data associated with at least one process pipeline;
a server in communication with the shared data storage and the central caching system;
wherein the server comprises at least one server processor configured to perform the steps of:
receiving client device self-assessment data representing a self-assessment of resources and functionalities by each client device of one or more client devices in communication with the at least one server processor;
determining a distribution of a plurality of processing tasks of the at least one process pipeline to be assigned across the at least one server processor and at least one of the one or more client devices based on the received client device self-assessment data;
distributing executable code and process data associated with each processing task of the plurality of processing tasks from the central caching system to the at least one of the one or more client devices, according to the distribution;
deriving a respective result for each respective processing task of the plurality of processing tasks distributed to the at least one server processor;
receiving results from the at least one of the one or more client devices; and
storing the respective result and the received results of the at least one process pipeline in the shared data storage.

12. The system of claim 11, wherein the self-assessment comprises at least one of network throughput, processor load, memory storage used and free, and embedded camera capabilities.

13. The system of claim 11, wherein the at least one server processor is further configured to maintain a library of self-assessment data for each client device.

14. The system of claim 11, wherein the executable code and process data are at least one of machine learning algorithms and artificial intelligence algorithms and the date they operate one and generate.

15. The system of claim 11, the at least one of the one or more client devices is a mobile device with a camera and the executable code and process data is processed within a web browser on the mobile device.

16. The system of claim 15, wherein the executable code is a vision processing code module that act on an incoming stream from the camera to identify a face of a user and mask the face as the results of the processing task.

17. The system of claim 11, wherein the server is part of a server cluster.

18. The system of claim 11, wherein the at least one server processor is further configured to determine a redistribution of each respective result from each respective processing task to the at least one of the one or more client devices.

19. The system of claim 18, wherein the processing task distributed to the at least one of the one or more client devices requires usage of the respective result derived by the at least one server processor.

20. The system of claim 11, wherein the process data for the processing tasks are provided within the shared memory for asynchronous access by the at least one of the one or more client devices when performing their respective processing tasks.
